(19) United States
(12) Patent Application Publication
(10) Pub. No.: US 2006/0095656 A1
(43) Pub. Date: May 4, 2006

(54) System and device for managing storage area network, volume allocation method, and computer software

(76) Inventors: Atsushi Ueoka, Yokohama (JP); Takeshi Ishizaki, Yokohama (JP); Kiminori Sugauchi, Yokokama (JP); Emiko Kobayashi, Yokohama (JP); Jun Mizuno, Yokohama (JP); Toui Miyawaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/988,492

(22) Filed: Nov. 16, 2004

(30) Foreign Application Priority Data
Sep. 10, 2004 (JP) 2004-263226

(51) Int. Cl. G06F 13/00

(52) U.S. Cl. 711/111

(57) ABSTRACT

The invention provides a management system solving the problems of the storage area network shared among plural devices, which was incapable of guaranteeing communication performances due to varied response time, and which required unstable time for accessing volumes.

The storage area network management system comprises plural information processing devices 21, plural storage devices 41, a network with plural network equipments 31 to which is configured a network bandwidth used for communication between information processing devices 21 and storage devices 41, and a management device 1, wherein management device 1 comprises a data storage device 10 for storing a connection structure information and a performance information of paths of the network equipments 31 and a performance information and a capacity information of storage devices 41, and a storage selection means 13 for selecting a storage device 41 for allocating a volume to information processing device 21, and upon allocating a volume to information processing device 21, storage selection means 13 selects, based on the information stored in data storage device 10, storage device 41 fulfilling the performance and the volume capacity required by information processing device 21 and also having on its path network equipment 31 to which is configured the network bandwidth required for the communication with information processing device 21.

The present application is based on and claims priority of Japanese patent application No. 2004-263226 filed on Sep. 10, 2004, the entire contents of which are hereby incorporated by reference.

### BACKGROUND OF THE INVENTION

1. Field of the Invention

The present invention relates to a method for allocating a volume to an information processing device in a storage area network.

2. Description of the Related Art

Storage devices connected to a network, so-called network storage devices, are utilized via a network by information processing devices. Network storage devices communicate with the information processing devices according to the protocol of the connecting network. There are various types of such networks, one of which is an IP (internet protocol) network.

Plural devices are connected to the IP network, and these devices share the network and communicate via the network simultaneously. Therefore, when a large amount of traffic occurs, communication data may be lost, or communication may be delayed. Thus, in a storage area network, the performance of the information processing device to access the volume allocated thereto is deteriorated, and it becomes impossible to exert the best performance of the storage devices.

In order to solve this problem, patent document 1 discloses a method for selecting the storage device for allocating the volume based on the response time and the number of network equipments between the information processing device and storage device when allocating a volume to the information processing device.

[Patent Document 1]

Japanese Patent Laid-Open Publication No. 2003-140930

### SUMMARY OF THE INVENTION

However, as described, since the IP network is shared by plural devices, the response time varies constantly. Therefore, it is not possible to guarantee the communication performance merely by response time and number of hops. Moreover, since the bandwidth enabling access from the information processing device to the volume is not guaranteed, the time required for accessing the volume may be unstable.

In order to solve the problems of the prior art, the present invention provides, in a storage area network using network equipments capable of guaranteeing the bandwidths to be used for every device performing communication through the network, a management device equipped with a data storage device for storing the information on the bandwidths of each network equipment and the reserved bandwidths, the connection structure of the network equipments and the information on the information processing devices and the storage devices connected to the storage area network, the management device being connected to the network equipments, the information processing devices and the storage devices. The management device is equipped with a first means for selecting the storage device that fulfils the performance of the storage device and the volume capacity required by the information processing device and that enables connection reserving the network bandwidth required by the information processing device, a second means for sending an instruction to the storage device to create the storage device a volume with a capacity required by the information processing device and to allocate the volume to the information processing device, and a third means for reserving the bandwidth required by the information processing device to the network equipment.

In other words, the present invention relates to a storage area network comprising: a plurality of information processing devices; a plurality of storage devices; a storage area network having the information processing devices and the storage devices connected thereto, and further having network equipments, each network equipment having configured thereto a network bandwidth used for communication between the information processing devices and the storage devices; and a management device connected to the information processing devices, the storage devices and the storage area network for management; wherein the management device comprises a data storage device for storing a connection structure information and a performance information of paths of the network equipments and a performance information and a capacity information of the storage devices, and a storage selection means for selecting a storage device for allocating a volume to the information processing device, and upon allocating a volume to the information processing device, the storage selection means selects, based on the information stored in the data storage device, the storage device having the performance and the volume capacity required by the information processing device and also having on its path the network equipment to which is configured the network bandwidth required for the communication with the information processing device.

According further to the present invention, the management device is equipped with an allocation instruction means for instructing the selected storage device to create a volume and to allocate the same to the information processing device, and the allocation instruction means sends to the storage device selected by the storage selection means an instruction to create the volume having the capacity required by the information processing device and an instruction to allocate the created volume to the information processing device.

According to the present invention, the management device comprises a configuration instruction means for instructing the network equipment constituting the path to configure the network bandwidth used by the information processing device and the selected storage device, and the configuration instruction means selects, based on the information stored in the data storage device, the network equipment connecting the information processing device and the storage device allocating the volume to the information processing device, and instructs the selected network equipment to configure the network bandwidth required by the information processing device.

The storage area network management system of the present invention further comprises an adjustment selection means, wherein when the storage selection means selects the storage device for allocating the volume, if there is a storage device fulfilling the storage device performance and the volume capacity required by the information processing device but there is no network equipment having configured thereto the network bandwidth required for the communication between the information processing device and the storage device, the adjustment selection means reduces the network bandwidth of the network equipment already configured between the information processing device and the storage device to volume units that have already been allocated, adjusts the network bandwidth between the information processing device and the storage device, and selects the storage device having reserved the network bandwidth for the newly allocated volume as the storage device for allocating the volume.

According further to the present storage area network management system, the management device comprises an output device and an input device, wherein when the storage selection means selects a plurality of storage devices, outputs to the output device information on the available capacity and performance of the selected plurality of storage devices and the available bandwidth of the network between the information processing device, and determines the storage device selected and instructed by the input device based on the information output to the output device to be the storage device for allocating the volume to the information processing device.

Further, the present invention provides a management device connected to and managing a plurality of information processing devices, a plurality of storage devices, and a storage area network having the information processing devices and the storage devices connected thereto, and further having network equipments, each network equipment having configured thereto a network bandwidth used for communication between the information processing devices and the storage devices, wherein the management device comprises a data storage device for storing a connection structure information and a performance information of paths of the network equipments and a performance information and a capacity information of the storage devices, and a storage selection means for selecting a storage device for allocating a volume to the information processing device, and upon allocating a volume to the information processing device, the storage selection means selects, based on the information stored in the data storage device, the storage device having the performance and the volume capacity required by the information processing device and also having on its path the network equipment to which is configured the network bandwidth required for the communication with the information processing device.

Further, the present invention provides a volume allocation method for a storage area network management system comprising a plurality of information processing devices; a plurality of storage devices; a storage area network having the information processing devices and the storage devices connected thereto and further having network equipments, each network equipment having configured thereto a network bandwidth used for communication between the information processing devices and the storage devices; and a management device connected to the information processing devices, the storage devices and the storage area network for management; the volume allocation method comprising: storing a connection structure information and a performance information of paths of the network equipments and a performance information and a capacity information of the storage devices; and selecting, based on the information stored in the data storage device, a storage device having the performance and the volume capacity required by the information processing device and also having on its path the network equipment to which is configured the network bandwidth required for the communication with the information processing device, for selecting the storage device for allocating the volume to the information processing device.

The volume allocation method according to the present invention further comprises instructing the selected storage device to create a volume with a capacity required by the information processing device, and sending to the selected storage device an instruction to allocate the created volume to the information processing device.

Moreover, the volume allocation method according to the present invention further comprises selecting, based on the information stored in the data storage device, the network equipment connecting the information processing device and the storage device allocating the volume to the information processing device, and instructing the selected network equipment to configure the network bandwidth required by the information processing device.

Even further, the volume allocation method according to the present invention further comprises upon selecting the storage device for allocating the volume, if there is a storage device fulfilling the storage device performance and the volume capacity required by the information processing device but there is no network equipment having configured thereto the network bandwidth required for the communication between the information processing device and the storage device, adjusting the network bandwidth between the information processing device and the storage device by reducing the network bandwidth of the network equipment already configured between the information processing device and the storage device to volume units that have already been allocated; and selecting the storage device having reserved the network bandwidth for the newly allocated volume to be the storage device for allocating the volume.

Furthermore, the volume allocation method according to the present invention comprises, when a plurality of storage devices are selected, outputting to the output device information on the available capacity and performance of the selected plurality of storage devices and the available bandwidth of the network between the storage devices, and determining the storage device selected and instructed by the input device based on the information output to the output device as the storage device for allocating the volume to the information processing device.

The present invention also provides a computer software used in a management device for a storage area network management system comprising a plurality of information processing devices; a plurality of storage devices; a storage area network having the information processing devices and the storage devices connected thereto and further having network equipments, each network equipment having configured thereto a network bandwidth used for communication between the information processing devices and the storage devices; and a management device connected to the information processing devices, the storage devices and the storage area network for management; the computer software being a program for realizing the following functions in a computer: a function for storing a connection structure information and a performance information of paths of the network equipments and a performance information and a capacity information of the storage devices; and a function for selecting, based on the information stored in the data storage device, a storage device having the performance and the volume capacity required by the information processing device and also having on its path the network equipment having configured the network bandwidth required for the communication with the information processing device, in order to select the storage device for allocating the volume to the information processing device.

According to the present invention, the storage device for allocating the volume is selected not only based on the capacity of the allocatable volume in the storage network but also based on the vacant bandwidth of the path for connecting the storage device and the information processing device. Therefore, it enables volume to be allocated easily to the information processing device. Further, since the bandwidth between the information processing device and the storage device is guaranteed, it prevents deterioration of performance of the service provided by the information processing device and also enables to exert the maximum performance of the storage device.

### BRIEF DESCRIPTION OF THE DRAWINGS

FIG. 1 is a drawing showing in simplified form the configuration of the storage area network management system of the present embodiment;

FIG. 2 is a drawing showing an example of the data layout of a storage device management information;

FIG. 3 is a drawing showing an example of the data layout of a server management information;

FIG. 4 is a drawing showing an example of the data layout of a network equipment management information;

FIG. 5 is a drawing showing an example of the data layout of a path information;

FIG. 6 is an example of the data layout of a volume allocation information;

FIG. 7 is an example of the process flow of a volume allocation program;

FIG. 8 is an example of the process flow by the volume allocation program for selecting a storage device for allocating the volume;

FIG. 9 is an example of the process flow by the volume allocation program for generating the volume in the storage device and allocating the same;

FIG. 10 is an example of the process flow by the volume allocation program for reserving the bandwidth of a network equipment that connects the server and storage device;

FIG. 11 is an example of the layout of data sent and received between the volume allocation program and the server or network equipments;

FIG. 12 is an example of the layout of a volume condition entry screen;

FIG. 13 is an example of the layout of a confirmation screen for confirming whether to search again for a volume;

FIG. 14 is an example of the layout of a storage device select screen;

FIG. 15 is an example of the layout of a volume allocating screen;

FIG. 16 is an example of the layout of a volume allocation complete screen;

FIG. 17 is an example of the layout of a bandwidth adjustment confirmation screen;

FIG. 18 is an example of the layout of a bandwidth adjustment screen; and

FIG. 19 is an example of the process flow by the volume allocation program for adjusting the bandwidth to be used for communication between the server and storage device.

### DETAILED DESCRIPTION OF THE PREFERRED EMBODIMENT

The preferred embodiments for carrying out the present invention will be described.

The preferred embodiments of the system and device for managing the storage area network and volume allocation method according to the present invention will now be described with reference to the drawings.

### Embodiment 1

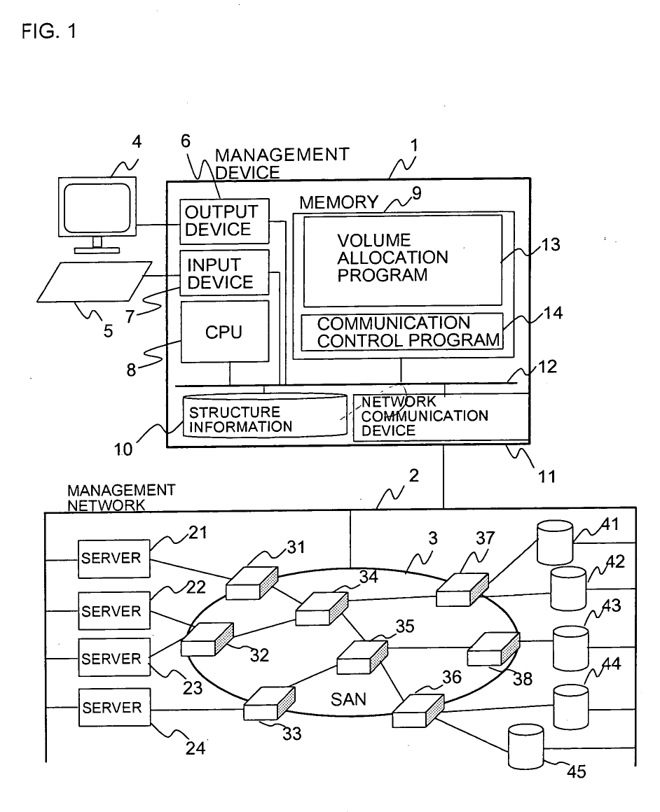

Embodiment 1 will be described. FIG. 1 illustrates an example of the configuration of a storage area network management system according to the present embodiment. A management device according to the present embodiment is equipped with a storage selection means, an allocation designation means, a configuration designation means and an adjustment selection means. Actually, in FIG. 1, the management device 1 is equipped with a central processing unit (CPU) 8, an output unit 6, an input unit 7, a memory 9, a structure information 10 and a network communication unit 11, which are connected via a bus 12. Only a single bus is illustrated in FIG. 1 for sake of simplicity, but plural buses can be used. Memory 9 stores a volume allocation program 13 that realizes the volume allocation method according to the storage area network management system of the present embodiment, and a communication control program 14. The communication control program 14 carries out the communication process by a communication protocol of a management network 2. This communication process corresponds to a TCP/IP process in an IP network. The volume allocation program 13 communicates via the communication control program 14 with servers 21 through 24, network equipments 31 through 38 and storage devices 41 through 45 respectively connected to the management network 2, to allocate volumes of storage devices 41 through 45 to the servers 21 through 24 and to configure the bandwidth to be used to the network equipments 31 through 38. The CPU 8 reads and executes the programs stored in the memory 9 according to parameters entered through a keyboard 5 connected to the input unit 7, and displays the result on a display unit 4 connected to the output unit 6. Structure information 10 stores information on storage devices 41 through 45, information on servers 21 through 24, information on network equipments 31 through 38, and information on the paths connecting the servers 21 through 24 and storage devices 41 through 45.

Reference number 3 denotes a storage area network (hereinafter called SAN) including network equipments 31 through 38. The network equipments 31 through 38 are capable of reserving the bandwidths to be used by the servers 21 through 24 and storage devices 41 through 45. Each of the network equipments 31 through 38 are connected to the management network 2 either directly or, indirectly via other network equipments. In FIG. 1, SAN 3 is illustrated as if it is directly connected to the management network 3 for sake of simplicity. Servers 21 through 24 are connected to the SAN 3 via network equipments 31 through 33. Storage devices 41 through 45 are connected to the SAN 3 via network equipments 36 through 38. Servers 21 through 24 can utilize the volumes of storage devices 41 through 45 via SAN 3. There is no limitation to the number of servers, the number of storage devices and the connection configuration and number of network equipments constituting the SAN.

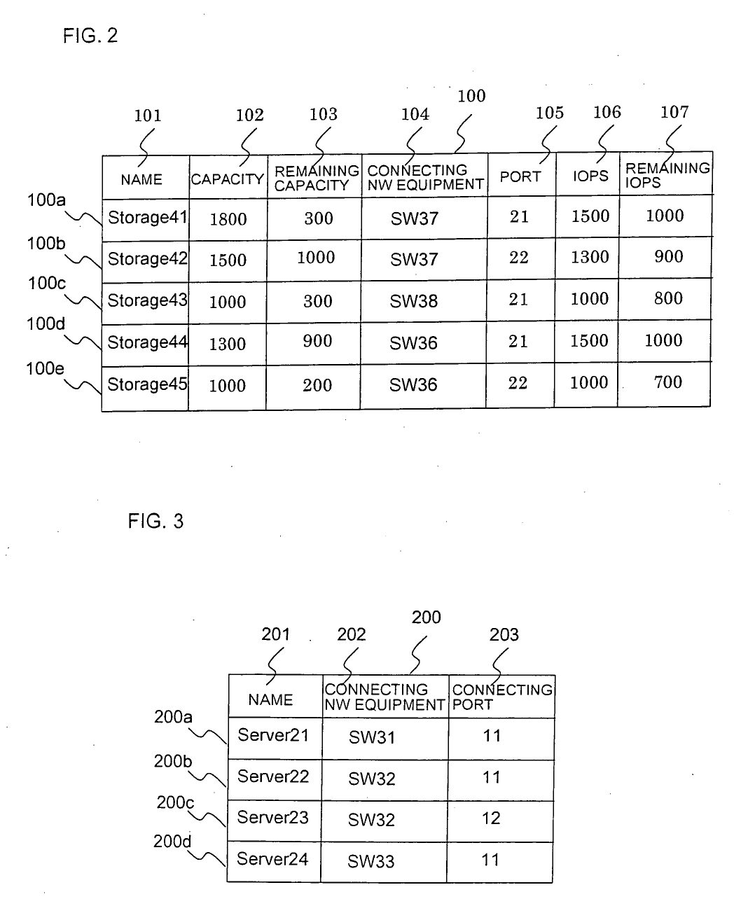

Next, the details of the data stored in the structure information 10 referred to by the volume allocation program 13 will be described with reference to FIGS. 2 through 6. FIG. 2 shows one example of a storage device management information 100 indicating the information related to storage devices 41 through 45 connected to SAN 3 stored in the structure information 10. The volume allocation program 13 refers to the storage device management information 100 and selects from the storage devices 41 through 45 candidates for allocating the volume to the servers 21 through 24. The storage device management information 100 is composed of a name 101 for identifying each storage device, a capacity 102 indicating the capacity of each storage device, a remaining capacity 103 indicating the remaining available capacity of each storage device, a connected NW equipment 104 for identifying the network equipment to which each storage device is connected, a port 105 indicating the connected port of the network equipment, an IOPS 106 indicating the number of inputs and outputs per second the storage device is capable of executing, and a remaining IOPS 107 indicating the IOPS that have not been reserved for use. Reference numbers 100a through 100e refer to records of storage devices 41 through 45 stored in the storage device management table 100. For example, it is shown by name 101 that record 100a stores information related to Storage 41. It can be seen that regarding Storage 41, the capacity is 1800, the remaining capacity is 300, the network equipment to which it is connected is SW 37, the connection port is 21, the IOPS is 1500 and the remaining IOPS is 1000.

FIG. 3 shows one example of a server management information 200 indicating the information on the servers 21 through 24 connected to SAN 3 stored in the structure information 10. The server management information 200 is composed of a name 201 for identifying the servers 21 through 24, a connected NW equipment 202 indicating the network equipments to which the servers 21 through 24 are connected, and a connection port 203 indicating the port of the network equipment to which the servers are connected. Reference numbers 200a through 200d refer to records indicating information on servers 21 through 24 stored in the server management information 200. For example, reference number 200a shows that name 201 corresponds to the record storing information related to Server 21, and that Server 21 is connected to port 11 of network equipment SW31.

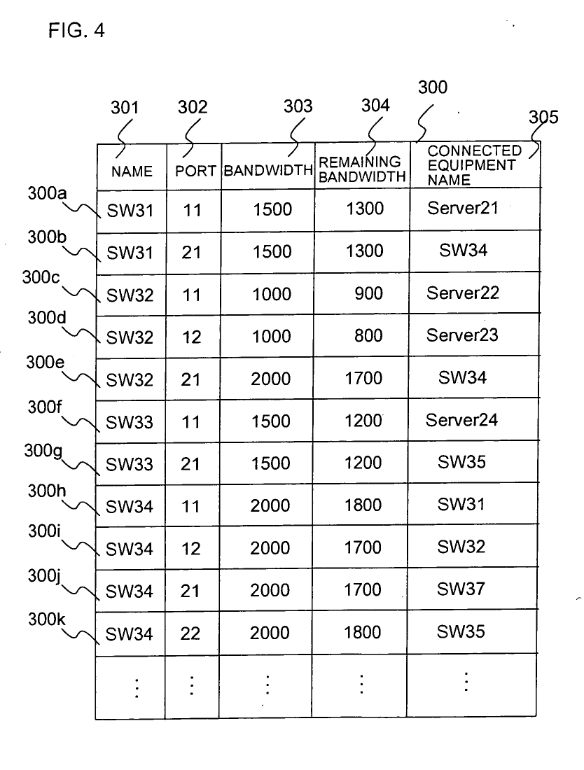

FIG. 4 shows one example of a network equipment management information 300 indicating information on network equipments 31 through 38 constituting the SAN 3 stored in the structure information 10. The network equipment management information 300 is composed of a name 301 for identifying the network equipments, a port 302 used for communication with other equipments, a bandwidth 303 indicating the maximum bandwidth of the port identified in port 302, a remaining bandwidth 304 indicating the unused bandwidth of the port identified in port 302, and a connected equipment name 305 identifying the equipment connected to the port identified in port 302. Reference numbers 300a through 300k indicate records related to network equipments 31 through 34 stored in the network equipment management information 300. For example, record 300a is a record storing information related to network equipment whose name 301 is SW31, indicating that the maximum bandwidth of port 11 is 1500, the remaining bandwidth is 1300, and the equipment being connected is Server 21. Moreover, from record 300b, it can be seen that the network equipment SW31 has a port 21 whose maximum bandwidth is 1500, remaining bandwidth is 1300 and to which is connected SW34.

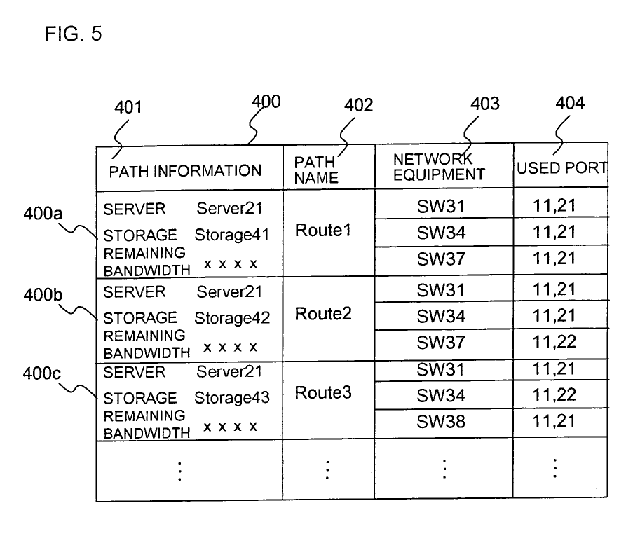

FIG. 5 shows one example of a data layout of a path information 400 stored in the structure information 10 indicating the path between the server and storage device. The path information 400 is composed of a path information 401 storing the names of the server and storage device for showing which record indicates the path between which server and storage device and the remaining bandwidth of that path, a path name 402 for identifying the path, a network equipment 403 indicating the network equipments constituting the path, and used port 404 indicating the ports used for the path. Reference numbers 400a through 400c indicate examples of path records stored in the path information 400. For example, as shown in path information 401, record 400b is a record related to the path between Server 21 and Storage 42 and has a remaining bandwidth of xxxx, and as indicated in path name 402, the name of the path is Route2. Further, based on network equipment 403, it can be seen that the network equipments constituting the path Route2 are SW31, SW34 and SW37. Further, based on used port 404, it can be seen that SW31 uses ports 11 and 22, SW34 uses ports 11 and 21, and SW37 uses ports 11 and 22.

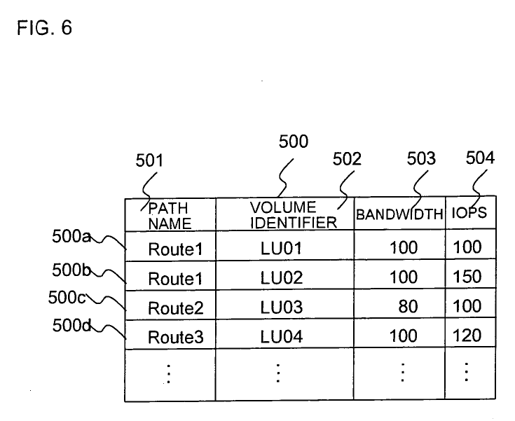

FIG. 6 shows one example of a data layout of volume allocation information 500 indicating information on the allocated volume in the paths of each record in the path information 400 shown in FIG. 5. The volume allocation information 500 is composed of a path name 501 used to identify the record of the path information 400, a volume identifier 502 for identifying the volume allocated to each path, a bandwidth 503 indicating the bandwidth of the network allocated to use the volume, and an IOPS 504 indicating the IOPS of the storage device allocated for use of the volume. Reference numbers 500a through 500d show examples of records stored in the volume allocation information 500. For example, records 500a and 500b are records related to path Route1 as indicated in path name 501, and it can be seen from volume identifier 502 that volumes LU01 and LU02 are allocated to Route1. Further, it can be seen from bandwidth 503 and IOPS 504 that the bandwidth of the network used by volume LU01 is 100 and the IOPS of the storage device is 100, and that the bandwidth of the network used by volume LU02 is 80 and the IOPS of the storage device is 150.

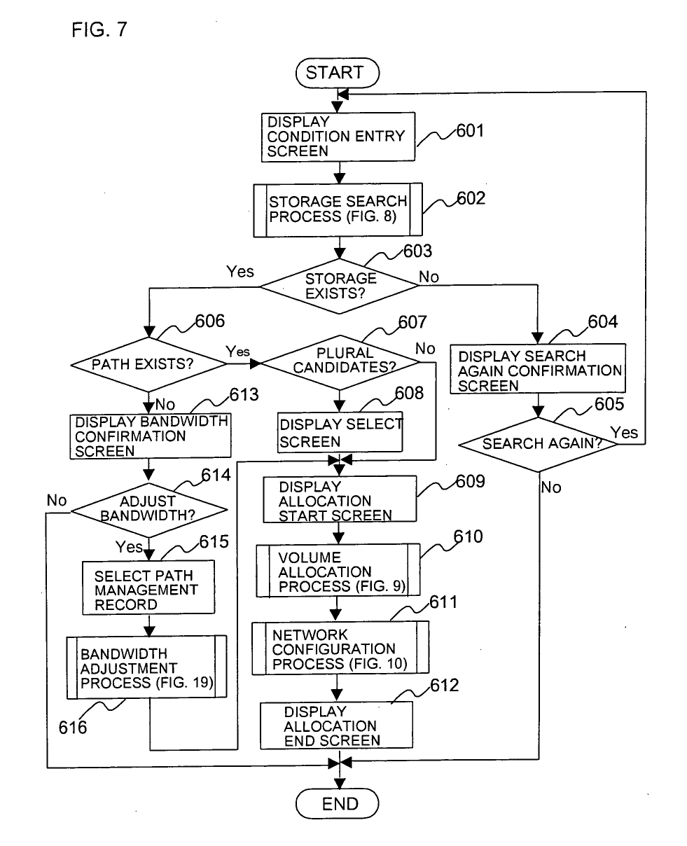

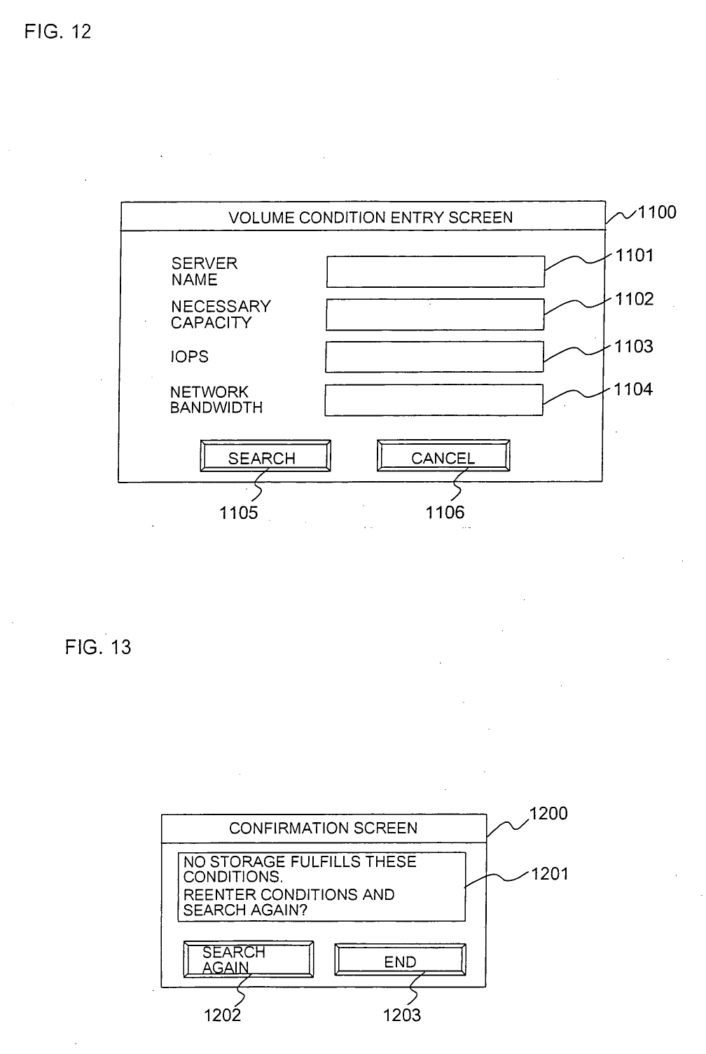

Next, FIGS. 7 through 19 are referred to in describing an example of the procedure of the volume allocation program 13 that realizes the volume allocation method in the storage area network management system according to the present embodiment. FIG. 7 is a process flow for allocating the volumes according to the volume allocation program 13. In step 601, the volume allocation program 13 displays on an output device a volume condition entry screen 1100 for entering the conditions of the volume to be allocated to the server. FIG. 12 shows an example of the volume condition entry screen 1100. The volume condition entry screen 1100 includes an area 1101 for entering the name of the server to which the volume is to be allocated, an area 1102 for entering the necessary capacity of the volume to be allocated, an area 1103 for entering the IOPS of the storage device required when the server utilizes the volume, an area 1104 for entering the bandwidth of the network required when the server utilizes the volume, a search button 1105 for instructing to start a search for a storage device for allocating the volume based on the conditions of areas 1101 through 1104, and a cancel button 1106 for canceling the entry of conditions. The administrator of SAN3 enters conditions of areas 1101 through 1104 on the volume condition entry screen 1100, and selects the search button 1105 to advance to step 602. In step 602, the storage device that fulfills the conditions entered on the volume condition entry screen 1100 is searched.

Next in step 603, whether there exists a storage device that fulfills the necessary capacity and IOPS entered on the volume condition entry screen 1100 is determined based on the result of the search conducted in step 602, and if there is no existing storage device, the procedure advances to step 604 where a screen 1200 for confirming whether to reenter conditions and search again for a storage device or to end the process is displayed. FIG. 13 shows an example of the confirmation screen 1200. The confirmations creen 1200 includes a message 1201 indicating that there is no storage device that fulfills the conditions, a search again button 1202 for reentering the conditions and searching for a storage device, and an end button 1203 for terminating the process. Step 605 determines the button being selected on this screen, and if search is to be executed again, that is, when the search again button 1201 is selected, the process is executed again from step 601. If the process is to be ended, that is, when the end button 1202 is selected, the volume allocation program 13 is ended. If the candidate storage device has been successfully searched in step 603, whether or not there is a path that fulfills the network bandwidth entered on the volume condition entry screen 1100 to connect with the storage device is determined in step 606, and if there is a path that fulfills the conditions, the procedure advances to step 607, and if there is no path, the procedure advances to step 613.

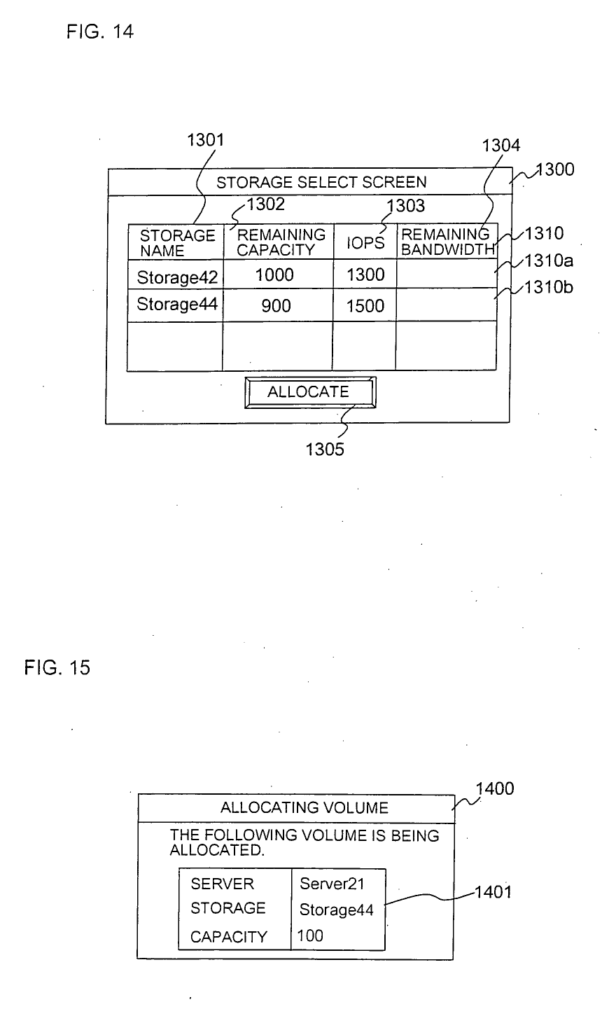

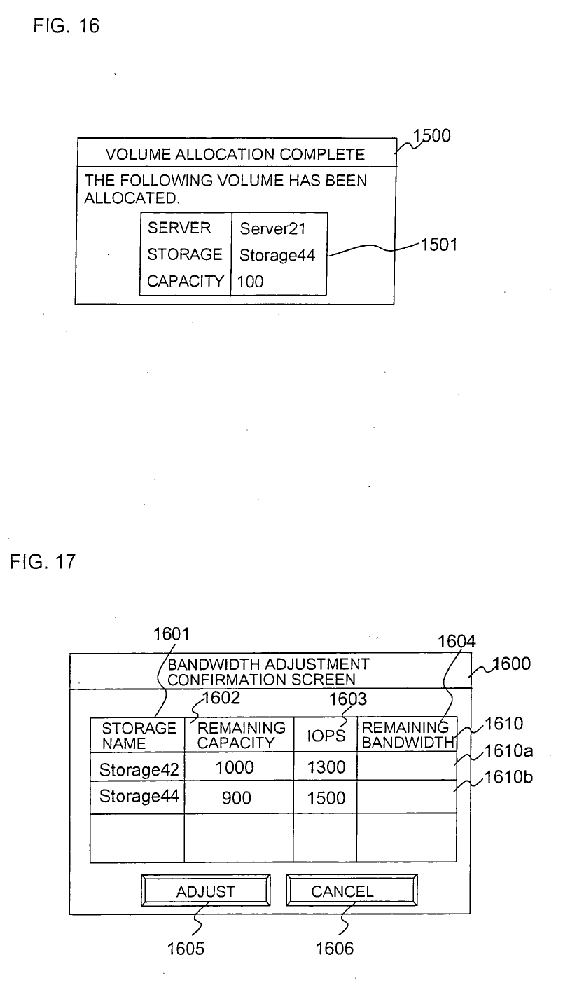

In step 607, the number of candidate storage devices is determined. If there are plural storage devices as candidates, the procedure advances via step 608 to step 609, and if there is only one candidate storage device, step 609 is carried out. In step 608, a storage select screen 1300 is displayed for selecting one storage device out of the plural candidate storage devices. FIG. 14 shows an example of a storage select screen 1300. The storage select screen 1300 includes an area 1310 for indicating the list of candidate storages, and an allocation button 1305 for instructing to allocate volume to the storage device being selected in area 1310. The area 1310 includes a storage name 1301 indicating the names of the candidate storage devices, a remaining capacity 1302 of the storage devices, an IOPS 1303 showing the remaining IOPS of the storage devices, and a remaining bandwidth 1304 of the path to the storage devices. As denoted by reference numbers 1310a and 1310b, the candidate storage devices are shown. The administrator determines the storage device for allocating the volume by selecting the storage device for allocating the volume out of the candidate storage devices indicated in area 1310 and selecting the allocation button 1305. In step 609, a volume allocating screen 1400 is displayed, indicating that allocation is being executed. FIG. 15 shows an example of a volume allocating screen. The volume allocating screen 1400 displays the server, the storage device and the capacity of the volume in area 1401. Thereafter, in step 610, a volume having the demanded capacity is created in the selected storage device, and the volume is allocated to the server. Then in step 611, the demanded bandwidth is reserved with respect to the server to which the volume is allocated and the network equipments connecting the selected storage device, and in step 612, a volume allocation complete screen 1500 indicating that allocation has been completed is displayed, and the process is terminated. FIG. 16 shows an example of the volume allocation complete screen. The volume allocation complete screen 1500 displays in area 1501 the server, the storage device and the capacity of the volume for which allocation has been completed.

Steps 613 through 616 correspond to the process in which there is a storage device fulfilling the entered required capacity and IOPS in the volume condition entry screen 1100 but the bandwidth of the path to the storage device does not fulfill the entered necessary bandwidth. At first, in process 613, a bandwidth adjustment confirmation screen 1600 is displayed. FIG. 17 shows an example of the bandwidth adjustment confirmation screen 1600. The bandwidth adjustment confirmation screen 1600 includes an area 1610 showing the list of candidate storage devices for allocating the volume, an adjustment button 1605 for instructing execution of bandwidth adjustment between the storage device selected in area 1610 and the server, and a cancel button 1606 for instructing not to execute bandwidth adjustment. Area 1610 includes a storage name 1601 indicating the names of candidate storage devices, a remaining capacity 1602 of the storage devices, an IOPS 1603 showing the remaining IOPS of the storage devices, and a remaining bandwidth 1604 showing the remaining bandwidth of the path to the storage devices. As denoted by reference numbers 1610a and 1610b, the candidate storage devices are shown. If bandwidth adjustment is to be executed, the storage device to be subjected to adjustment is selected from area 1610, and the adjustment button 1605 is selected. If bandwidth adjustment is not to be executed, the cancel button 1606 is selected. Next in step 614, the button being selected on the bandwidth adjustment confirmation screen 1600 is determined. If the cancel button 1606 has been selected, the process is ended. If the adjustment button is selected, in step 615, the path management record between the storage device being selected in the bandwidth adjustment confirmation screen 1600 and the server for allocating the volume is selected from the path information 400, and in step 616, the bandwidth adjustment process is executed. Thereafter, the procedure advances to step 609.

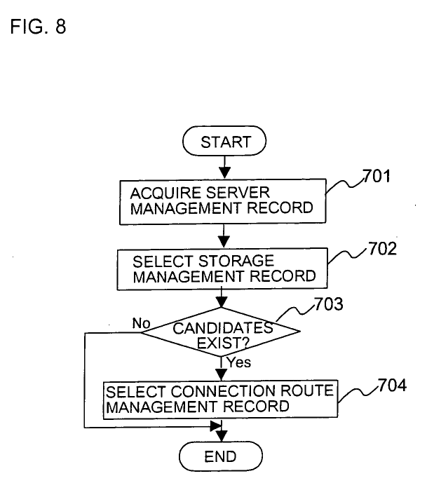

Next with reference to FIG. 8, the details of the storage search process of step 602 are described. FIG. 8 shows an example of a process flow related to searching for a storage device that fulfills the entered conditions. First in step 701, the server management record of the server for allocating the volume is selected from the server management information 200 and acquired. Next in step 702, the storage device capable of ensuring the required volume capacity and IOPS is selected based on the values of remaining capacity 103 and remaining IOPS 107 of the storage device management information 100. Thereafter, whether a storage device fulfilling the conditions had been successfully selected or not in step 702 is determined, and if not, the process is ended, but if there were candidates, step 704 is carried out. In step 704, a path record between the server and the storage device selected in step 702 for allocating the volume is selected from the path information 400 based on the contents of path information 401, and the process is ended. At this time, only the record showing the remaining bandwidth capable of reserving the required bandwidth of the network is selected.

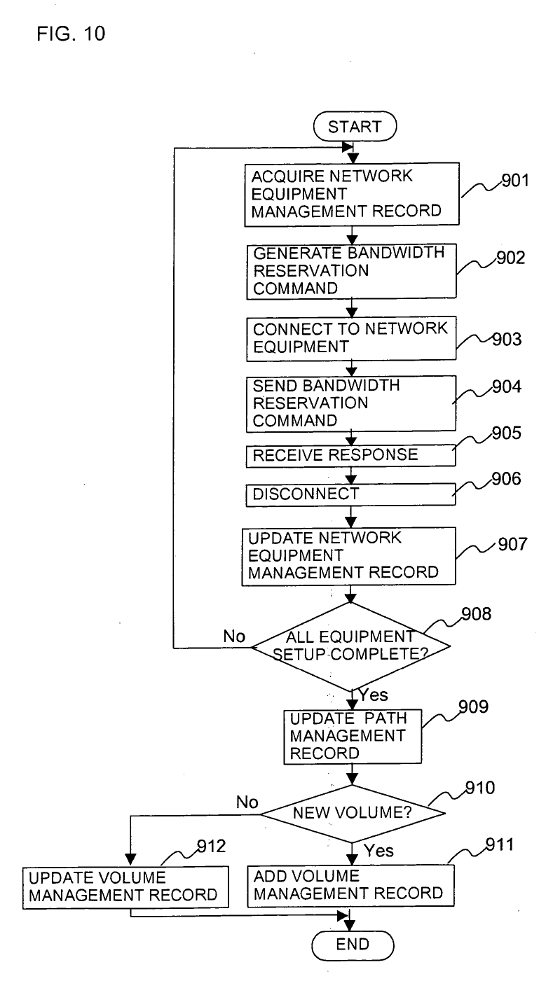

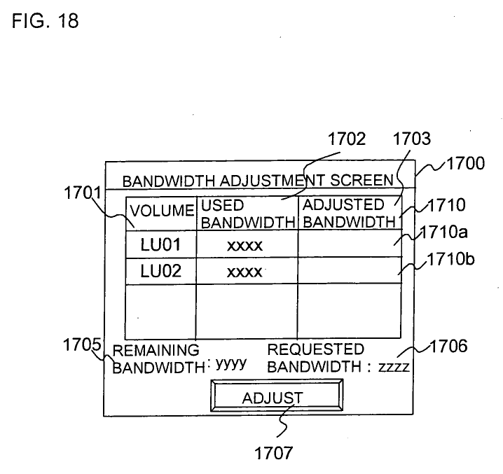

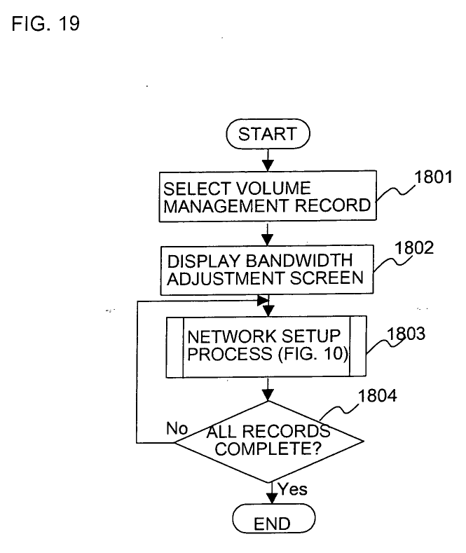

Next with reference to FIG. 19, the details of the bandwidth adjustment process of step 616 are described. FIG. 19 shows an example of a process flow for adjusting the bandwidth to be used between the server and the storage device. At first, in step 1801, the volume management record corresponding to the path name 402 of the path management information 400 (FIG. 5) selected in step 615 and the path name 501 of the volume allocation information 500 (FIG. 6) is selected. Next in step 1802, a bandwidth adjustment screen 1700 is displayed. FIG. 18 shows an example of a bandwidth adjustment screen 1700. The bandwidth adjustment screen includes an area 1710 for displaying the information on the volume management record acquired in step 1810, a remaining bandwidth display area 1705 indicating the remaining bandwidth between the server and storage device, a requested bandwidth display area 1706 indicating the necessary capacity 1102 entered through the volume condition entry screen 1100, and an adjustment button 1707. The volume management record display area 1710 includes a volume 1701 for displaying the contents of the volume identifier 502 of the volume management record, a use bandwidth 1702 showing the bandwidth reserved for use of the volume shown in volume 1701, in other words, the bandwidth 503 of the volume management record, and an adjusted bandwidth 1703 for entering the bandwidth after adjustment. In area 1710, the data of the volume management record selected in step 1801 are listed as denoted by reference numbers 1710a and 1710b. The remaining bandwidth is calculated based on the values entered in each adjusted bandwidth 1703, and the value shown in remaining bandwidth 1705 is changed to the calculated remaining bandwidth. Thereafter, when the adjustment button 1707 is selected, the procedure advances to step 1803 of FIG. 19. In step 1803, the network configuration process of FIG. 10 is executed in order to change the reserved bandwidth of each of the volumes being changed in the bandwidth adjustment screen 1700. Next, in step 1804, it is confirmed whether step 1803 has been performed for all the volume management records, and if not, the procedure returns to step 1803, but if it has been completely performed, the process is ended.

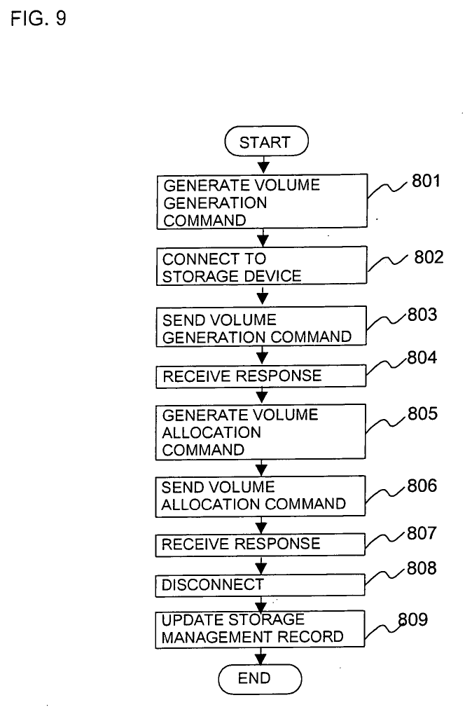

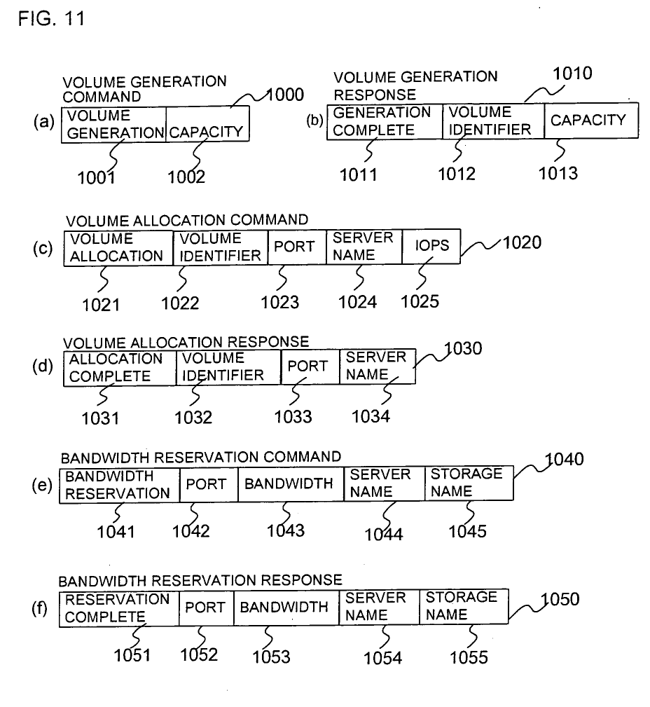

Next, the details of step 611 will be described with reference to FIG. 9. FIG. 9 is an example of a process flow for generating a volume in a storage device and designating the volume to be allocated to the server. First, in step 801, a volume generation command 1000 for generating a volume to the storage device is generated. FIG. 11(a) shows one example of the layout of the volume generation command 1000. The volume generation command 1000 discloses the contents of the transmission data, and is composed of a volume generation 1001 showing that it is a command for generating volume, and a capacity 1002 designated as the capacity of the volume being generated. Next in step 802, the storage device in which volume is generated is connected via the management network 2, and in step 803, the volume generation command 1000 is transmitted. Next in step 804, a volume generation response 1010 which is a response indicating the result of execution of the volume generation command 1000 is received from the storage device. The volume generation response 1010, one example of which is shown in FIG. 11(b), is composed of a generation complete 1011 indicating the contents of the transmission data, a volume identifier 1012 for identifying the generated volume, and a capacity 1013 indicating the capacity of the generated volume. After receiving this volume generation response 1010, a volume allocation command 1020 is generated in step 805, and the volume allocation command 1020 is sent to the storage device in step 806. The volume allocation command 1020, one example of which is shown in FIG. 11(c), is composed of a volume allocation 1021 showing the volume allocation which is the content of the transmission data, a volume identifier 1022 showing the identifier of the volume to be allocated, a port 1023 showing the port to be used for communication with the server for which the volume is allocated, a Server name 1024 showing the server for which the volume is allocated, and an IOPS 1025 showing the IOPS used by the server for which the volume is allocated for utilizing this volume. After the volume allocation command 1020 is transmitted to the storage device, a volume allocation response 1030 which is a response showing the result of execution of the volume allocation command 1020 is received in step 807, and the connection with the storage device is disconnected in step 808. The volume allocation response 1030, one example of which is shown in FIG. 11(d), is composed of an allocation complete 1031 showing completion of allocation which is the content of the transmission data, a volume identifier 1032 for identifying the allocated volume, a port 1033 showing the port of the storage device to be used when the server attempts to use the allocated volume, and a Server name 1034 indicating the server to which the volume is allocated. After cutting off the connection with the storage device in step 808, the remaining capacity 103 and the capacity and IOPS of the volume for which the remaining IOPS 107 has been allocated of the storage management record of the storage device information 100 corresponding to the storage device for which the volume has been allocated are updated to the subtracted values in step 809.

Next, the details of the process of step 611 will be described with reference to FIG. 10. FIG. 10 shows one example of a process flow for reserving the bandwidth with respect to the network equipments 31 through 38 constituting the SAN 3. At first in step 901, a network equipment 403 of the path record in the path information 400 selected in step 704 or step 615 is acquired in step 901, and a network equipment management record of the network equipment management information 300 related to this network equipment is acquired. Next in step 902, a bandwidth reservation command 1040 to be transmitted to the network equipment shown by the name 301 of the acquired network equipment management record is generated. The bandwidth reservation command 1040, one example of which is shown in FIG. 11(e), is composed of a bandwidth reservation 1041 showing the reservation command of the bandwidth which is the content of the transmission data, a port 1042 showing the port of the network equipment for reserving the bandwidth, a bandwidth 1043 showing the bandwidth to be reserved, a Server name 1044 showing the server using the reserved bandwidth, and a storage 1044 showing the storage device. Next in process 903, connection is formed to the network equipment shown by the name 301 on the acquired network equipment management record, and in step 904, the generated bandwidth reservation command 1040 is sent to the connected network equipment. Thereafter, in step 905, a bandwidth reservation response 1050 showing the response to the bandwidth reservation command 1040 is received from the network equipment. The bandwidth reservation response 1050, one example of which is shown in FIG. 11(f), is composed of a reservation complete 1051 which is the content of the transmission data, a port 1052 indicating the port of the network equipment for which the bandwidth has been reserved, a bandwidth 1053 indicating the reserved bandwidth, a Server name 1054 indicating the server using the reserved bandwidth, and a storage name 1055 indicating the storage device that uses the reserved bandwidth. After receiving bandwidth reservation response 1050, in step 906, the connection with the network equipment is cut off, and in step 907, the bandwidth is updated to a value subtracting the reserved bandwidth from the remaining bandwidth of the network equipment management record acquired in step 901. Next in step 908, whether or not bandwidth reservation has been performed for all the network equipments listed in network equipment 403 of the path record is confirmed. If bandwidth reservation is not performed for all the network equipments, the procedure returns to step 901, and if the bandwidth reservation for all the network equipments has been completed, the procedure advances to step 909. In step 909, the value of the residual bandwidth contained in the path information 401 of the path management record is updated to a value subtracting the reserved bandwidth. Next in step 910, whether the volume is a new volume or not is determined, and if it is new, a volume allocation record related to the allocated volume is generated in step 911, which is added to the volume management record 500 and the process is ended. If it is not new, the volume management record is updated in step 912 and the process is ended.

By the processes mentioned above, the procedure for selecting the storage device capable of reserving the designated capacity, the IOPS and the network bandwidth, allocating the volume to the server, and reserving the bandwidth of the network equipments is completed.

As mentioned above, the volume allocation method in the storage area network management system according to the present embodiment selects candidate storage devices 41 through 45 for allocating the volume based on the remaining capacity and remaining IOPS of the storage devices 41 through 45 required by the server upon allocating a volume to the servers 21 through 24, selects a storage device 41 through 45 that can be connected via a path having a remaining bandwidth that fulfills the network bandwidth required by the server, allocates the volume, and reserves the bandwidth used by the servers 21 through 24 and the storage devices 41 through 45 in which the volume is generated in network equipments 31 through 38 constituting the path between the servers 21 through 24 and the storage devices 41 through 45. Therefore, the servers 21 through 24 are capable of effectively guaranteeing the bandwidth of the network required for the servers 21 through 24 to use the volumes of the storage devices 41 through 45. Moreover, since not only the configuration of the storage devices 41 through 45 but also the configuration of the network equipments 31 through 48 can be set, the number of management steps can be cut down effectively.

A management device was explained according to the above embodiment, but a computer or the like can be adopted as the management device of the present invention by using a computer software recording medium storing a computer program for enabling the computer to realize a function to store the connection structure information of the network equipment, the performance information of the path, and the performance information and capacity information of the storage device, and a function to select, based on stored information, the storage device that fulfills both the volume capacity and performance required by the information processing device and that comprises in its path network equipments capable of reserving the bandwidth of the network required for the communication with the information processing device, and to allocate the volume of that storage device to the image processing device. Further, a server or a storage device can be the management device of the present invention by providing the functions of the management device to the server or storage device.

What is claimed is:

1. A storage area network management system comprising:
a plurality of information processing devices;
a plurality of storage devices;
a storage area network having the information processing devices and the storage devices connected thereto, and further having network equipments, each network equipment having configured thereto a network bandwidth used for communication between the information processing devices and the storage devices; and
a management device connected to the information processing devices, the storage devices and the storage area network for management,
wherein the management device comprises a data storage device for storing a connection structure information and a performance information of paths of the network equipments and a performance information and a capacity information of the storage devices, and a storage selection means for selecting a storage device for allocating a volume to the information processing device, and upon allocating a volume to the information processing device, the storage selection means selects, based on the information stored in the data storage device, the storage device having the performance and the volume capacity required by the information processing device and also having on its path the network equipment to which is configured the network bandwidth required for the communication with the information processing device.

2. The storage area network management system according to claim 1, wherein
the management device is equipped with an allocation instruction means for instructing the selected storage device to create a volume and to allocate the same to the information processing device, and the allocation instruction means sends to the storage device selected by the storage selection means an instruction to create the volume having the capacity required by the information processing device and an instruction to allocate the created volume to the information processing device.

3. The storage area network management system according to claim 2, wherein
the management device comprises a configuration instruction means for instructing the network equipment constituting the path to configure the network bandwidth used by the information processing device and the selected storage device, and the configuration instruction means selects, based on the information stored in the data storage device, the network equipment for connecting the information processing device and the storage device allocating the volume to the information processing device, and instructs the selected network equipment to configure the network bandwidth required by the information processing device.

4. The storage area network management system according to claim 1, further comprising
an adjustment selection means, wherein when the storage selection means selects the storage device for allocating the volume, if there is a storage device fulfilling the storage device performance and the volume capacity required by the information processing device but there is no network equipment having configured thereto the network bandwidth required for the communication between the information processing device and the storage device, the adjustment selection means reduces the network bandwidth of the network equipment already configured between the information processing device and the storage device to volume units that have already been allocated, adjusts the network bandwidth between the information processing device and the storage device, and selects the storage device having reserved the network bandwidth for the newly allocated volume as the storage device for allocating the volume.

5. The storage area network management system according to claim 1, wherein
the management device comprises an output device and an input device, wherein when the storage selection means selects a plurality of said storage devices, outputs to the output device information on the available capacity and performance of the selected plurality of storage devices and the available bandwidth of the network between the information processing device, and determines the storage device selected and instructed by the input device based on the information output to the output device to be the storage device for allocating the volume to the information processing device.

6. A management device connected to and managing a plurality of information processing devices, a plurality of storage devices, and a storage area network having the information processing devices and the storage devices connected thereto, and further having network equipments, each network equipment having configured thereto a network bandwidth used for communication between the information processing devices and the storage devices,
wherein the management device comprises a data storage device for storing a connection structure information and a performance information of paths of the network equipments and a performance information and a capacity information of the storage devices, and a storage selection means for selecting a storage device for allocating a volume to the information processing device, and upon allocating a volume to the information processing device, the storage selection means selects, based on the information stored in the data storage device, the storage device having the performance and the volume capacity required by the information processing device and also having on its path the network equipment to which is configured the network bandwidth required for the communication with the information processing device.

7. A volume allocation method for a storage area network management system comprising a plurality of information processing devices; a plurality of storage devices; a storage area network having the information processing devices and the storage devices connected thereto and further having network equipments, each network equipment having configured thereto a network bandwidth used for communication between the information processing devices and the storage devices; and a management device connected to the information processing devices, the storage devices and the storage area network for management, the volume allocation method comprising:
storing a connection structure information and a performance information of paths of the network equipments and a performance information and a capacity information of the storage devices; and
selecting, based on the information stored in the data storage device, a storage device having the performance and the volume capacity required by the information processing device and also having on its path the network equipment to which is configured the network bandwidth required for the communication with the information processing device, for selecting the storage device for allocating the volume to the information processing device.

8. The volume allocation method according to claim 7, further comprising:
instructing the selected storage device to create a volume having a capacity required by the information processing device; and
sending to the selected storage device an instruction to allocate the created volume to the information processing device.

9. The volume allocation method according to claim 8, further comprising:
selecting, based on the information stored in the data storage device, the network equipment for connecting the information processing device and the storage device allocating the volume to the information processing device; and
instructing the selected network equipment to configure the network bandwidth required by the information processing device.

10. The volume allocation method according to claim 7, further comprising:
upon selecting the storage device for allocating the volume, if there is a storage device fulfilling the storage device performance and the volume capacity required by the information processing device but there is no network equipment to which is configured the network bandwidth required for the communication between the information processing device and the storage device, adjusting the network bandwidth between the information processing device and the storage device by reducing the network bandwidth of the network equipment already configured between the information processing device and the storage device to volume units that have already been allocated; and
selecting the storage device having reserved the network bandwidth for the newly allocated volume to be the storage device for allocating the volume.

11. The volume allocation method according to claim 7, further comprising:
when a plurality of said storage devices are selected, outputting to the output device information on the available capacity and performance of the selected plurality of storage devices and the available bandwidth of the network between the information processing devices and storage devices; and
determining the storage device selected and instructed by the input device based on the information output to the output device to be the storage device for allocating the volume to the information processing device.

12. A computer software used in a management device for a storage area network management system comprising a plurality of information processing devices; a plurality of storage devices; a storage area network having the information processing devices and the storage devices connected thereto and further having network equipments, each network equipment having configured thereto a network bandwidth used for communication between the information processing devices and the storage devices; and a management device connected to the information processing devices, the storage devices and the storage area network for management,
the computer software being a program for realizing the following functions in a computer:
a function for storing a connection structure information and a performance information of paths of the network equipments and a performance information and a capacity information of the storage devices; and
a function for selecting, based on the information stored in the data storage device, a storage device having the performance and the volume capacity required by the information processing device and also having on its path the network equipment to which is configured the network bandwidth required for the communication with the information processing device, in order to select the storage device for allocating the volume to the information processing device.
